(19) United States
(12) Patent Application Publication
(10) Pub. No.: US 2015/0070373 A1
(43) Pub. Date: Mar. 12, 2015

(54) Clarification of Zoomed Text Embedded in Images

(71) Applicant: Jason Clinton, Boulder, CO (US)

(72) Inventor: Jason Clinton, Boulder, CO (US)

(73) Assignee: GOOGLE INC., Mountain View, CA (US)

(21) Appl. No.: 13/593,300

(22) Filed: Aug. 23, 2012

(51) Int. Cl. G09G 5/377

(52) U.S. Cl. 345/589

(57) ABSTRACT

Described herein are technologies related to clarification of zoomed text embedded in images. This Abstract is submitted with the understanding that it will not be used to interpret or limit the scope or meaning of the claims. A clarification tool includes a raster, edge-finding filter configured to identify text embedded in images, a pattern recognition tool configured to match the identified text against a database of font-families and patterns, a text grouping tool configured to group text into a word region, a font-family selector tool configured to select the proper font-family to use to clarify the embedded text for the word region and a rendering engine configured to render the clarified text in a text display tool.

### BACKGROUND

Because of their limited screen size, users of mobile devices often zoom-in on a displayed image. Sometimes, these images include text embedded therein. When zoomed or enlarged, the embedded text may appear blurry or pixelated. While conventional mobile devices make use of texture filtering to reduce the appearance of pixilation in an image, this texture filtering does not improve the clarity of image content.

Thus, when a device displays apparent text that is embedded in an image, that text is often difficult to read or completely unreadable when zoomed or enlarged.

### SUMMARY

The technologies described herein are related to text clarification in embedded images. In accordance with one or more implementation described herein, a clarification tool includes a raster, edge-finding filter configured to identify text embedded in images, a pattern recognition tool configured to match the identified text against a database of font-families and patterns, a text grouping tool configured to group text into a word region, a font-family selector tool configured to select the proper font-family to use to clarify the embedded text for the word region and a rendering engine configured to render the clarified text in a text display tool.

This Summary is submitted with the understanding that it will not be used to interpret or limit the scope or meaning of the claims. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic representation illustrating an example process for clarification of zoomed text embedded in an image in accordance with an implementation of the present technology.

FIG. 2 is a block diagram illustrating an example device implementing clarification of zoomed text embedded in an image in accordance with an implementation of the present technology.

FIG. 3 is a flow chart illustrating an example process for implementing clarification of zoomed text embedded in an image in accordance with an implementation of the present technology.

FIG. 4 is a block diagram illustrating an example of a system for clarification of zoomed text embedded an image in accordance with an implementation of the present technology.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies for clarification of zoomed text that are embedded in images. These technologies will differentiate the textual-appearing content embedded in images on a web page or other electronic document, identify this content, find/match the font codes for this content, and then generate/render appropriately sized text representing this content in the matched font much like what is seen on the web page text.

### Overview

Modern web browsers on computers and mobile devices make use of zooming to improve the accessibility of content for people with low or impaired vision and to make content readable on small screens. Unfortunately, web sites often embed text inside of images: in banners, buttons or other visual elements. When browsers zoom-in on a web page, they succeed at improving the clarity of any plain text in the web page by increasing the size of the rendered, vector graphics or characters (i.e., texts or glyphs). However, they fail to improve the clarity of text embedded in any images on the web page. A glyph is an element of writing including single characters that are each self-contained units of written text or punctuation—a vector, spline-based representation of an individual character in a language.

The text found in or otherwise embedded in an image is not a glyph. Rather, it is part of the image itself. In computer graphics, that image (i.e., raster graphics image, bitmap) is a dot matrix data structure representing a generally rectangular grid of pixels viewable by a monitor, paper, or other display medium.

Raster graphics are resolution dependent. They cannot scale up to various resolutions without loss of apparent quality resulting in pixilation or a blurry image appearance. However, as mentioned above vector graphics can easily scale up to the quality of the device rendering them.

More specifically, vector graphics may be described as the use of geometric characteristics such as points, lines, curves, and shapes or polygons, which are all based on mathematical expressions, to represent images in computer graphics.

In the technologies described herein, clarity is maintained in a web page when a browser increases the font size of symbol-encoded text of a web page because it redraws the text that is already encoded as vector graphics. However, clarity is lost in textual-appearing content in a raster graphics image during enlargement because the bits making up the “text” are not encoded and are not differentiated from any other bits in the image.

An implementation in accordance with the technologies described herein draws from four major technological foundations together to improve the clarity of text in images: image filtering, image pattern recognition, a database of commonly used font-families and their patterns, and browser-based, client-side canvas compositing to produce zoomed images with clear text. These technologies makes it easier for a user to read zoomed text embedded over images in a web page or electronic document.

The technology may be applied to any web browser rendering engine, such as those shared among tablet computers and/or smartphone mobile devices. The technology may be applied further to the rendering of web pages or E-books (which often contain poor quality scans of original published graphics, maps and technical diagrams).

### Example Zoomed-Text Clarification Device

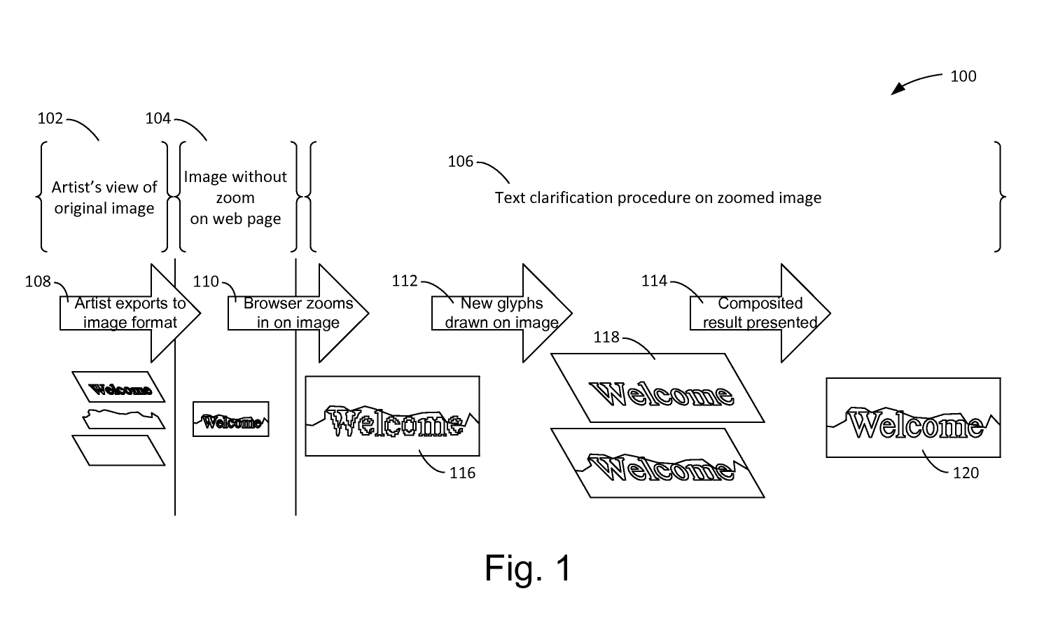

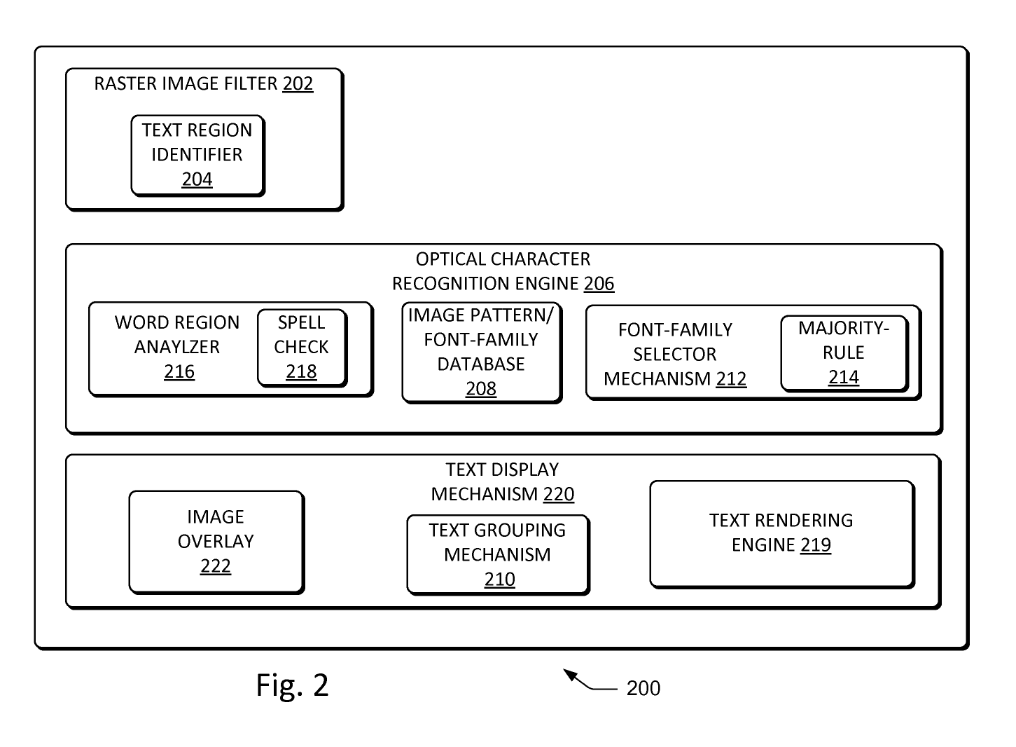

FIG. 1 illustrates a diagrammatic representation showing an example process 100 of clarification of zoomed in text embedded in an image. Example process 100 shows in general a view of an original banner image 102, an image without zoom on a web page 104, and the text clarification procedure on zoomed image 106. In more detail, after the image exports to image format 108, the browser zooms in on image 110. Next, new texts are drawn on image 112 and finally the composited result 114 is presented. Additionally, FIG. 1 depicts an area of the image that may be referred to as a word region 116 (e.g., “Welcome”). As discussed in FIG. 2, the word region 116 is clarified, zoomed into word region 118. The clarified word region 118 is overlaid and composited onto the original image 102 as new image 120.

FIG. 2 shows an example zoomed-text clarification device 200 implementing clarification of zoomed text embedded in images in accordance with an implementation of the present technology. As depicted, device 200 includes a raster image filter 202, optical character recognition (OCR) engine 206, and a text display mechanism 220.

The raster image filter 202 is configured to perform a level of image filtering with regard to contrasts or inverse imaging. For instance, image filter 202 may scan image pixels and lock in the image by performing multiple passes. For example, a pass may locate any text embedded in the image as 100% black or 80% gray on a white background. Further, the image filter 202 may include a text region identifier 204 configured to distinguish what is text and what is an image and subsequent passes through filter 202 may lock in the edges of the text and recognize the font of interest. Examples of approaches that may be employed to identify regions that are likely to contain text are edge-finding approaches or a discreet cosine transform amongst others. This occurs before any OCR and font recognition function has been performed.

The OCR engine 206 includes image pattern/font-family database 208, a font-family mechanism 212, and a word-region analyzer 216. The OCR engine is used to capture the text and font-family of the image(s) scanned. OCR 206 may include an image pattern/font-family database 208 configured to match image patterns and font-families to textual content found by text region identifier 204. For example, an out-of-the-box OCR software package may be augmented/linked with database 208 and used. The proposed database would contain the “signatures” for each glyph of the most popular fonts. After the normal OCR process were completed, the second pass would look among all the ‘a’s, for example, to find the glyph with the signature that most closely approximates the one detected.

By way of example, OCRopus™ is an open source OCR engine, that allows pluggable back-ends for character recognition; within the OCRopus™ project, IRecognizeLine is the name of the interface for just such an extension and implementing the additional font-family weighting as a module for that interface is an example of one way by which adapting/augmenting an off-the-shelf OCR implementation could be achieved.

The IRecognizeLine interface is for text line recognizers. In its most common form, it is used to transform images of text lines into recognition lattices. An implementation may process through each letter of every word and match that letter against all known signatures for that letter in the augmented glyph database. At the end of a word, if, for example, the characters most closely approximated ‘Times New Roman’ and two characters most closely approximated ‘Georgia’, the engine would return ‘Times New Roman’ for the whole word based on the assumption that artists do not typically change fonts in the middle of a word.

A given text or glyph may be defined as a single character in a font-family. The text or glyph is an element, which can be defined further as a self-contained unit in a language. Some texts are based on proximity to each other (i.e., dual characters). East Asian languages have a concept of a text so they can still be described as a self-contained unit represented by a vector to render the texts as well. Thus, the term text is applicable to any language. The text display mechanism 220 includes text grouping mechanism 210, a text rendering engine, and an image overlay 222. With the text grouping mechanism 210, the device 200 groups the identified textual content into word regions as depicted in FIG. 1 at word region 116. A word region is, for example, a group of identified texts that form a word (e.g., “Welcome”) and a font-family used in embedded text in an image is comprised of a library of texts.

Since textual content is usually rendered by the web page authors using a single font, the OCR engine 206 discussed above is configured to bias an entire word region toward only one font-family. This biasing is performed toward a particular font-family, which occurs most often during the OCR process.

Moreover, device 200 uses the font-family selector mechanism 212 to select a font found in database 208 that matches the word region. The font-family selector mechanism 212 may include a majority rule 214 which specifies which font occurred within any given word region the most or the majority of the time. The majority rule 214 will then select the font that occurred the most as the font for the entire word region.

Now device 200 uses the word region analyzer 216 configured to analyze the word region in a client-side device for a user. Word region analyzer 216 may include a spell check 218 to insure that the word region has no misspellings or the like. Spell check 218 may be configured as any conventional spell check but without a grammar check feature.

OCR engines identify word regions as a normal part of their process. Once the augmented OCR engine returns the words detected and their coordinates and font families, the process would look for opportunities to combine adjacent words in to sentences that occur on the same line. Again, on the assumption that artists do not change fonts in the middle of sentences, the device 200 may choose to render an entire line with a single font despite the OCR engine determining that slightly different fonts were detected in adjacent words.

The text-rendering engine 219 is configured to render text that corresponds to the matched pattern and font-family determined by the font-family selector mechanism 212 and majority rule 214 as described above.

Finally, device 200 uses a text display mechanism 220 configured to display the rendered text over the original image via an image overlay 222 as depicted in FIG. 1 as clarified word region 118. Image overlay 222 is configured to composite and detect the location of the original image using the colors and coordinates of the originally detected contiguous solid-color regions of the image. The color might be determined by sampling color underneath the vector region that would be covered by the rendering of text that is about to take place. The rendered text is scaled using the same scaling as in use for the plain text in the given web page and the coordinates are adjusted so that the rendered text substantially covers the original image text.

### Example Process Implementation

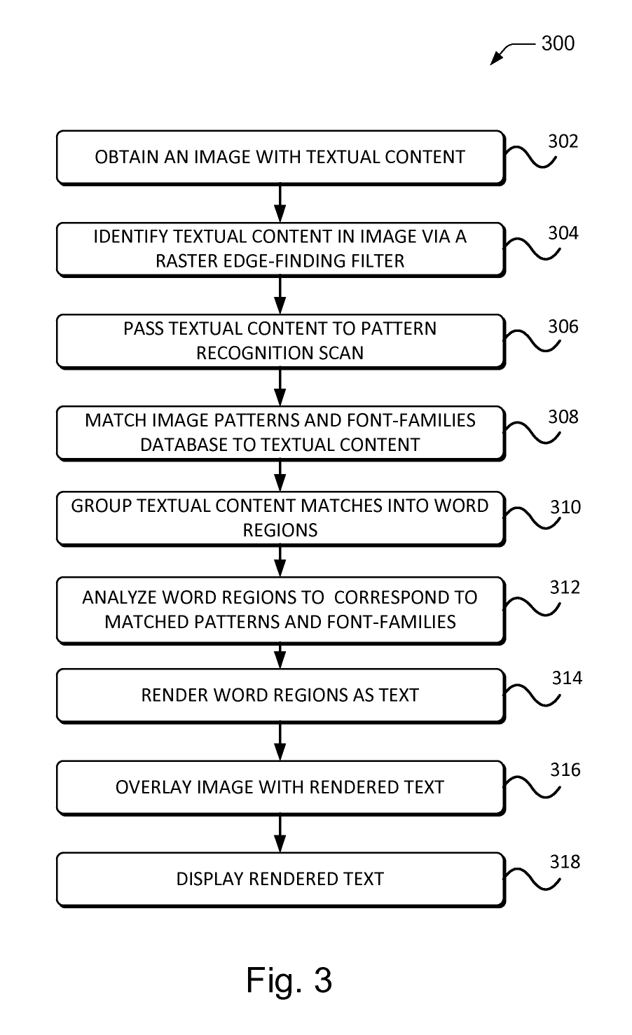

FIG. 3 depicts a flow chart showing an example process 300 that implements the techniques described herein for clarification of zoomed text embedded in an image. The process 300 may be performed, at least in part, by a browser-client device (not shown) showing web page content.

At 302, the process 300 begins with the browser client device obtaining an image with textual content and then, at 304, identifying any images embedded with textual content by applying a raster, edge-finding filter to all images embedded in the web page. The filter finds contiguous regions of solid colors. Photographs do not typically contain such regions (though line art does). This is a first-pass attempt to avoid images that have no text. Referring again to FIG. 1, a banner image 102 might be processed that contains the word “Welcome” in black text on a photographic background wherein the filter identifies each letter as a region of contiguous black color.

At 306, the identified text regions are passed to additional pattern recognition. This may be done as part of the initial OCR scan or after initial OCR scan is complete. For example, a less intense OCR scan may be performed. At 308, the browser client matches (if possible) the identified textual content against a database of defined text patterns and their font-families (such as database 108 in FIG. 1). For instance in FIG. 1, the act might find that the “W” in “Welcome” most closely matches the upper-case “W” from the font-family “Georgia Bold” while all other characters most closely match the lower-case variants of their counterparts from the font-family “Times New Roman.”

Next, at 310, once a candidate match for each text is identified, the browser client groups texts that are spatially located close to each other into a word region and a majority-rule 114 technique is performed to make a font-family selection and to clarify the embedded text for that particular word region. By way of the above example, a ranking may be applied such as 1 point is assigned to “Georgia Bold” and 6 points is assigned to “Times New Roman” making “Times New Roman” the winning or majority font-family for that particular word region.

Optionally, during a second-pass pattern recognition inside the same OCR engine 106, for each word region, the second-pass pattern recognition is done on each text region at a lower sensitivity but only selecting from a pool of texts in a majority-rule font-family for a particular word region. The text selected in the second-pass is assumed to be the correct text. For example in FIG. 2, “W” “e” “1” “c” “o” “m” “e” might be the result (notice that the number 1 might be detected in place of a lower-case “l”).

OCR engines detect gaps of space between glyph regions and represent these spatially separated areas as distinct words. This has conventionally been used to augment the OCR engine by way of performing spell check. However, with the new techniques described herein, the same internal data structures are used to weight words in to font-family weighting groups.

Optionally, a spell-check 118 is applied to correct miss-identified word region sub-texts. The most likely candidate's correct spelling is then chosen. For instance in FIG. 1, “Welcome” becomes “Welcome”.

At 312, the browser client analyzes word regions and determines which the font-family and pattern that corresponds thereto. At 314, the browser client renders with the same text overlaying the original image in order to stand out over the blurry text zoomed in underneath.

During the OCR action of 306, the client-side device or browser produces coordinates, words and font data. Based upon that data, the browser client, at 316, renders the text over the original zoomed image. At 318, the rendered text is displayed on the screen. The rendered text may be a slightly larger and bolder to overlay the rendered text over the original zoomed, unclarified image and displayed 318.

Modern OCR engines store the coordinates of the detected, corrected and converted glyph and word regions. For example, many PDF documents contain both original scans of paper documents as well as the OCR results to facilitate copy-and-paste from the document. However, the new techniques described herein reuse this locality data from the OCR engine to inform the text rendering process: the text is painted on the image at the coordinates for the words conveyed from the OCR engines internal representation.

In the browser rendering engine, each chosen replacement text is rendered and composited over the top of the originally detected text location in the original image, respectively, using the coordinates of the originally detected contiguous solid-color regions. The rendered text is then scaled using the same scaling as in use for the zoomed image in the web page and the coordinates are adjusted so that the rendered text substantially covers the original image text with each respective replacement text.

This process is illustrated as a collection of blocks in a logical flow graph, which represents a sequence of operations that can be implemented in mechanics alone or a combination with hardware, software, and/or firmware. In the context of software/firmware, the blocks represent instructions stored on one or more computer-readable storage media that, when executed by one or more processors, perform the recited operations.

Note that the order in which the process are described is not intended to be construed as a limitation, and any number of the described process blocks can be combined in any order to implement the process or an alternate process. Additionally, individual blocks may be deleted from the process without departing from the spirit and scope of the subject matter described herein.

### Additional and Alternative Implementation Notes

Alternatively and in further implementations, the technology described herein may omit the use of an initial edge-finding filter 102 and go directly to the first pass at pattern recognition by enhancing the efficiency of the pattern recognition algorithm inside the OCR engine 106. Additionally, the technology described herein may perform all computation and composting operations on a remote server (e.g. in the cloud) to off-load the task from the end-user device or a user may skip the spell checking 118 or use a statistical model rather than dictionary-based matching, to bias toward complete words. Moreover, the technology may redefine “word” to mean entire regions of text that statistically and commonly occur next to each other in a given language. Furthermore, the technology may avoid human languages in which the concept of individual words comprised of contiguous texts does not apply (e.g. many Eastern Asian languages). In addition, the technology might avoid rendering the original image entirely (e.g. in a “high accessibility, high contrast” mode) and render the matched text as plain web page text, directly.

Additionally, the technologies described herein may be used in ebooks by applying the techniques either to ebook documents before loading the documents into a client-device thus bypassing the computational process (i.e., document scan-side of ebooks) or by applying them in the ebooks (i.e., client-side). Either way, the result would render clear embedded text within the ebook document.

Alternatively, a tangential variation on the technology described herein may be used by in-vehicle camera (i.e., computer vision) and heads up display (HUD) systems to enhance the visibility of text of on the road signs by rendering the detected text onto the windshield via HUD in the line-of-sight between the driver's eyes and the road sign.

As used herein, a browser program module is computer program that is designed to be executed by a computer or other computing system. A mobile browser program module is a similar computer program module that designed to be executed on a mobile computing device, such as a so-called smartphone.

Any suitable type of technology can be utilized to implement the technologies and techniques described herein. Examples of suitable, known technologies include (by way of example and not limitation): any mobile device (e.g., smartphones, tablets, ebooks, etc.) and any touchscreen device (e.g., all-in-one desktops, etc.). Again, the technologies described herein may include either client side or server side uses depending where it is desired to do the computation.

### Example Computing System

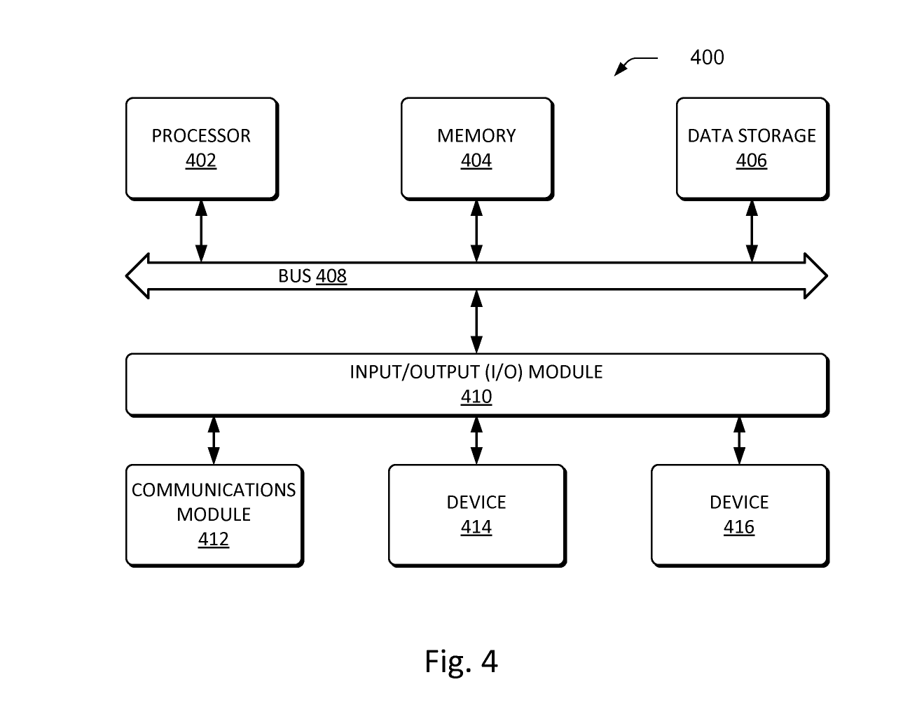

FIG. 4 depicts a high-level block diagram illustrating an example computer system 400 suitable for implementing the text clarification device 200 of FIG. 2. In certain aspects, the computer system 400 may be implemented using hardware or a combination of software and hardware.

The illustrated computer system 400 includes a processor 402, a memory 404, and data storage 406 coupled to a bus 408 or other communication mechanism for communicating information. An input/output (I/O) module 410 is also coupled to the bus 408. A communications module 412, a device 414, and a device 416 are coupled to the I/O module 410.

The processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. The processor 402 may be used for processing information. The processor 402 can be supplemented by, or incorporated in, special purpose logic circuitry.

The memory 404 may be Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device used for storing information, a computer program, and/or instructions to be executed by the processor 402. They memory 404 may store code that creates an execution environment for one or more computer programs used to implement technology described herein.

A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Unless indicated otherwise by the context, a module refers to a component that is hardware, firmware, and/or a combination thereof with software (e.g., a computer program.) A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The instructions may be implemented in one or more computer program products, i.e., one or more modules of computer program instructions encoded on one or more computer readable media for execution by, or to control the operation of, the computer system 400, and according to any method well known to those of skill in the art. The term “computer-readable media” includes computer-storage media. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

The data storage 406 may be a magnetic disk or optical disk, for example. The data storage 406 may function to store information and instructions to be used by the processor 402 and other components in the computer system 400.

The bus 408 may be any suitable mechanism that allows information to be exchanged between components coupled to the bus 508. For example, the bus 408 may be transmission media such as coaxial cables, copper wire, and fiber optics, optical signals, and the like.

The I/O module 410 can be any input/output module. Example input/output modules 410 include data ports such as Universal Serial Bus (USB) ports.

The communications module 412 may include networking interface cards, such as Ethernet cards and modems.

The device 414 may be an input device. Example devices 414 include a keyboard, a pointing device, a mouse, or a trackball, by which a user can provide input to the computer system 400.

The device 416 may be an output device. Example devices 416 include displays such as cathode ray tubes (CRT) or liquid crystal display (LCD) monitors that display information, such as web pages, for example, to the user.

One or more implementations are described herein with reference to illustrations for particular applications. It should be understood that the implementations are not intended to be limiting. Those skilled in the art with access to the teachings provided herein will recognize additional modifications, applications, and implementations within the scope thereof and additional fields in which the technology would be of significant utility. In the above description of example implementations, for purposes of explanation, specific numbers, materials, configurations, and other details are set forth in order to better explain implementations as claimed. However, it will be apparent to one skilled in the art that the claims may be practiced using details different from the examples described herein. In other instances, well-known features are omitted or simplified to clarify the description of the example implementations.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

The inventors intend the described example implementations to be primarily examples. The inventors do not intend these example implementations to limit the scope of the appended claims. Rather, the inventors have contemplated that the claimed technology might also be embodied and implemented in other ways, in conjunction with other present or future technologies.

Moreover, any aspect or design described herein as “example” is not necessarily to be construed as preferred or advantageous over other aspects or designs. Rather, use of the word example is intended to present concepts and techniques in a concrete fashion. The term “techniques,” for instance, may refer to one or more devices, apparatuses, systems, methods, articles of manufacture, and/or computer-readable instructions as indicated by the context described herein.

In the claims appended herein, the inventor invokes 35 U.S.C. §112, paragraph 6 only when the words “means for” or “steps for” are used in the claim. If such words are not used in a claim, then the inventor does not intend for the claim to be construed to cover the corresponding structure, material, or acts described herein (and equivalents thereof) in accordance with 35 U.S.C. §112, paragraph 6.

What is claimed is:

1. A method that facilitates text clarification, the method comprising:
obtaining an image that has textual content;
identifying the textual content by filtering the image via a raster, edge-finding filter to locate the textual content within the image by finding contiguous regions of solid colors in the image;
passing the identified textual content to a high-sensitivity pattern recognition scan;
matching the identified textual content to a database of defined image patterns and font-families;
grouping the identified textual content into word regions by associating any identified textual content that is spaced proximal to one another into the word regions;
analyzing the word regions to correspond to the matched patterns and font-families;
rendering the word regions as text; and
displaying the rendered text overlaid with the word regions in the image.

2. A method as recited in claim 1 wherein the analyzing includes:
determining a scale of the rendered text for the matched patterns and font-families; and
adjusting the scale of the rendered text to match the scale of the identified textual content.

3. A method as recited in claim 1 wherein the analyzing includes applying a spell check to the word regions.

4. A method as recited in claim 1 wherein the analyzing includes determining a font-family for the word regions.

5. A method as recited in claim 4 wherein the determining includes:
applying a majority rule to select a font for the word regions, wherein the majority of the matched patterns and font-families with respect to the identified textual content is the chosen patterns and font-families for the word regions.

6. A method as recited in claim 1 wherein the overlaying includes:
compositing the rendered word regions over the top of an image location by using coordinates of the contiguous regions of solid colors in the image.

7. A method as recited in claim 6 wherein the overlaying includes:
scaling the rendered word regions to represent an enlarged image of the obtained image.

8. A method as recited in claim 1 wherein the analyzing, further includes:
applying a low-sensitivity pattern recognition scan to the word regions, wherein the pattern recognition scan is configured to only select the matched patterns and font-families for the word regions by the majority rule.

9. A computing system comprising a web browser program module that includes one or more computer-readable media having stored thereon instructions that, when executed on one or more processors, direct the one or more processors to perform the method as recited in claim 1.

10. A mobile computing system comprising a mobile web browser program module that includes one or more computer-readable media having stored thereon instructions that, when executed on one or more processors, direct the one or more processors to perform the method as recited in claim 1.

11. A system that facilitates text clarification comprising:
an image filter configured to apply a raster, edge-finding filter to an image to identify any textual content within the image by finding contiguous regions of solid colors in the image;
an optical character recognition (OCR) engine configured to apply a high-sensitivity optical character recognition scan to the identified textual content, wherein the OCR engine includes an image pattern and font-family database;
a text grouping mechanism configured to group the identified text content into word regions by associating any identified textual content that is spaced proximal to one another into the word regions;
a font-family selector mechanism configured to select and match a font-family from the image pattern and font-family database to the word regions;
a word region analyzer configured to analyze the word regions to render text that corresponds to the matched pattern and font-family;
a text-rendering engine configured to render the text to correspond to the matched pattern and font-family; and
a display configured to display and overlay the rendered text.

12. A system as recited in claim 11 wherein the word region analyzer is configured to:
determine a scale of the rendered text for the matched pattern and font-family of the word region; and
adjust the scale of the rendered text to match the scale of the word region in the image.

13. A system as recited in claim 11 wherein the display is configured to:
composite the rendered word regions over the top of an image location by using coordinates of the contiguous regions of solid colors in the image.

14. A system as recited in claim 11 wherein the image pattern and font-family database is configured to hold defined image patterns and font-families and to match the patterns and font-families to the corresponding identified textual content.

15. A system as recited in claim 11 wherein the font-family selector mechanism is configured to apply a majority rule to select a font for the word regions, wherein the majority of the matched pattern and font-family with respect to the identified textual content is the chosen pattern and font-family for the word regions.

16. One or more computer-readable media having stored thereon instructions that, when executed on one or more processors, direct the one or more processors to perform operations for text clarification, the operations comprising:
obtaining an image that has textual content;
identifying the textual content by filtering the image via a raster, edge-finding filter to locate the textual content within the image by finding contiguous regions of solid colors in the image;
passing the identified textual content to a high-sensitivity pattern recognition scan;
matching the identified textual content to a database of defined image patterns and font-families;
grouping the identified textual content into word regions by associating any identified textual content that is spaced proximal to one another into the word regions;
analyzing the word regions to correspond to the matched patterns and font-families;
rendering the word regions as text; and
displaying the rendered text overlaid with the word regions in the image.

17. One or more computer-readable media as recited in claim 16 wherein the analyzing includes:
determining a scale of the rendered text for the matched pattern and font-family of the word regions; and
adjusting the scale of the rendered text to match the scale of the word regions in the image.

18. One or more computer-readable media as recited in claim 16 wherein the analyzing includes:
applying a spell check to the word regions.

19. One or more computer-readable media as recited in claim 16, wherein the matching includes:
determining a font-family for the word region by applying a majority rule to select a font for the word regions, wherein the majority of the matched pattern and font-family with respect to the identified textual content is the chosen pattern and font-family for the word regions.

20. One or more computer-readable media as recited in claim 16, wherein the overlaying includes:
compositing the rendered word regions over the top of an image location by using coordinates of the contiguous regions of solid colors in the image.

21. One or more computer-readable media as recited in claim 20, wherein the overlaying includes:
scaling the rendered word regions to represent an enlarged image of the obtained image.

22. One or more computer-readable media as recited in claim 16, wherein the analyzing further includes:
applying a low-sensitivity pattern recognition scan to the word regions, wherein the pattern recognition scan is configured to only select the matched pattern and font-family for the word regions by the majority rule.
